(19) United States
(12) Patent Application Publication
(10) Pub. No.: US 2004/0016346 A1
(43) Pub. Date: Jan. 29, 2004

(54) Self-contained beverage proportioner unit

(75) Inventors: Derek Deubel, Pewaukee, WI (US); Jay C. Steinbrecher, Waukesha, WI (US); Peter N. Schultz, Milwaukee, WI (US); Raymond Woo, Waukesha, WI (US)

Correspondence Address: MICHAEL BEST & FRIEDRICH, LLP, 100 E WISCONSIN AVENUE, MILWAUKEE, WI, 53202, US

(73) Assignee: Klockner KHS, Inc., Waukesha, WI (US)

(21) Appl. No.: 10/366,649

(22) Filed: Feb. 13, 2003

Related U.S. Application Data
(60) Provisional application No. 60/356,529, filed on Feb. 13, 2002.

(51) Int. Cl. A23L 1/00

(52) U.S. Cl. 99/275

(57) ABSTRACT

A self-contained, modular proportioner unit includes a frame, a water handling assembly supported by the frame, a syrup handling assembly supported by the frame, and a controller supported by the frame. Each of the water handling assembly, the syrup handling assembly, and the controller are mounted in close relationship with one another, thereby minimizing the size of the proportioner unit.

### RELATED APPLICATIONS

This application claims priority to U.S. Provisional Application No. 60/356,529 filed Feb. 13, 2002.

### FIELD OF THE INVENTION

The invention relates to beverage blending systems, and more particularly to beverage blending systems designed for brix blending.

### BACKGROUND OF THE INVENTION

Many prior art beverage processing systems exist for blending together water and a syrup to yield a soft-drink product. One example of a prior art beverage processing system is illustrated schematically in FIG. 1. The prior art system 10 includes a deaeration stage having a deaeration vessel 14 where air is removed from a supply of treated water using CO₂ injection and a vacuum pump 18. The water is recirculated through the vessel 14 by a recirculating pump 22.

The deaerated water is then pumped via a water pump 26 into one or more water reservoirs 30 for the proportioning stage. The proportioning stage also includes one or more syrup reservoirs 34 supplied with a desired syrup. The water and syrup levels within the respective reservoirs are carefully controlled and held constant. CO₂ is also present in the water reservoirs 30 and the syrup reservoir 34. The water and the syrup are fed via gravity into a mixing chamber 38 using the “head-over-orifice” principle. Specifically, water flows into the mixing chamber 38 through an adjustable water micrometer 42 and syrup flows into the mixing chamber through a fixed orifice 46. The mixing chamber 38 is operated at a pressure that is less than atmospheric pressure so the water and syrup orifices 42 and 46 perform as though there were a ten to twenty foot column of liquid above them, depending on the operator settings.

The water and syrup are mixed in the mixing chamber 38 and then pumped via a mix pump 50 to the carbonating stage of the system 10. The carbonating stage includes a carbonation tank 54 where CO₂ is absorbed by the water/syrup mixture. A booster pump 58 then helps pump the carbonated product to the filler (not shown) for filling into the desired containers.

With a typical prior art system like the one shown in FIG. 1, all of the components are packaged together in a tight, self-contained configuration to facilitate installation and to reduce space consumption in the processing plants. Usually, the components are all mounted on a single frame or skid that can be readily moved from place to place using a fork truck.

### SUMMARY OF THE INVENTION

Head-over-orifice type proportioning systems, also known as volumetric proportioning or metering systems, are somewhat problematic in that the accuracy of ingredient metering can be affected by variations in temperature, pressure, and viscosity. Typical volumetric proportioning systems achieve a blending accuracy on the order of about ±0.10° brix to ±0.05° brix during steady-state operation. Degrees brix is a measure of blending accuracy, i.e., how much beverage syrup is blended with water. In addition to the relatively low blending accuracy at steady-state, volumetric proportioning systems also generate significant product loss at startup and run-out. Much of this loss can be attributed to operator error during product changeover.

Hundreds of complete beverage processing systems utilizing volumetric proportioning systems are currently in use around the world. These systems are expensive, and the decision to replace such a system with a new, complete system capable of achieving better proportioning performance is difficult to justify. Therefore, a need exists for an improved proportioning unit that can be quickly and easily added as an upgrade to existing blending systems for a fraction of the cost associated with total system replacement. The improved unit should have a compact, modular design suited for quick and easy installation and minimal space requirements. Improved blending accuracy and reduced product loss should also be achieved.

The invention provides such an improved proportioning unit upgrade. More specifically, the invention provides a self-contained proportioner unit configured to be substituted for an existing proportioner of a complete beverage mixing system. The proportioner unit includes a frame, a water handling assembly supported by the frame, a syrup handling assembly supported by the frame, and a controller supported by the frame. Each of the water handling assembly, the syrup handling assembly, and the controller are mounted in close relationship with one another, thereby minimizing the size of the proportioner unit.

Once the proportioner unit is placed adjacent the existing beverage blending system, the existing integrated proportioner is removed or otherwise rendered inoperable. Water and syrup supplies are routed into the new proportioner unit and the blended syrup/water mixture is routed back into the existing carbonation tank, effectively bypassing the old proportioner. The water and syrup handling assemblies are equipped with conveniently-located inlet valves that facilitate making connections with the existing deaeration tank and syrup supply tanks. Likewise, the syrup/water mixture outlet is easily connected to the existing system for fluid communication with the carbonation tank.

The proportioner unit preferably utilizes mass flow metering technology automatically controlled by the controller. Coriolis-type flow meters are used in the water and syrup handling assemblies and permit the product to be blended on a weight basis rather than a volume basis, yielding higher blending accuracy at startup, steady-state, and run-out. Additionally, the mass flow meters in combination with the controller software operate to greatly reduce the product loss. The controller of the proportioner unit can also be used to control all of the other functions of the existing blending system, thereby eliminating much of the older, relay contact technology being used.

The invention also provides a method of upgrading a pre-existing beverage blending system having an integral proportioner to achieve improved proportioning performance and accuracy. The method includes providing a self-contained proportioner unit in nearby relation to the pre-existing system and bypassing the pre-existing integral proportioner. Bypassing is achieved by directing a water supply and a syrup supply from the pre-existing system into the self-contained proportioner unit for blending, and then directing the blended water and syrup mixture back into the pre-existing system. The pre-existing integral proportioner can be rendered inoperable and left in place, or can be removed from the existing system altogether.

Other features and advantages of the invention will become apparent to those skilled in the art upon review of the following detailed description and drawings.

### BRIEF DESCRIPTION OF THE DRAWINGS

FIG. 1 is a schematic illustration of a prior art beverage processing system.

FIG. 2 is a front view of a self-contained beverage proportioner unit embodying the invention.

FIG. 3 is a rear view of the beverage proportioner unit of FIG. 2.

FIG. 4 is a side view of the beverage proportioner unit of FIG. 2.

FIG. 5 is a perspective view showing the water handling assembly and the syrup handling assembly of the beverage proportioner unit.

FIG. 6 is a schematic illustration showing the proportioner unit connected to a carbonation tank.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION OF THE PREFERRED EMBODIMENT

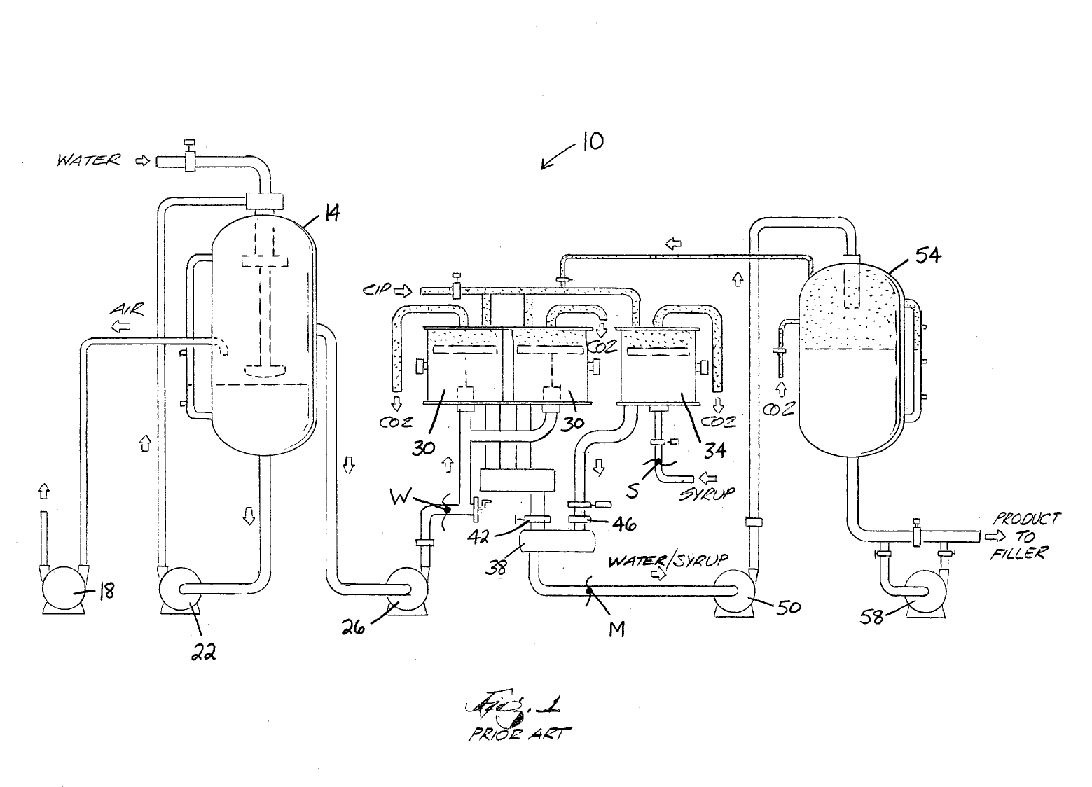

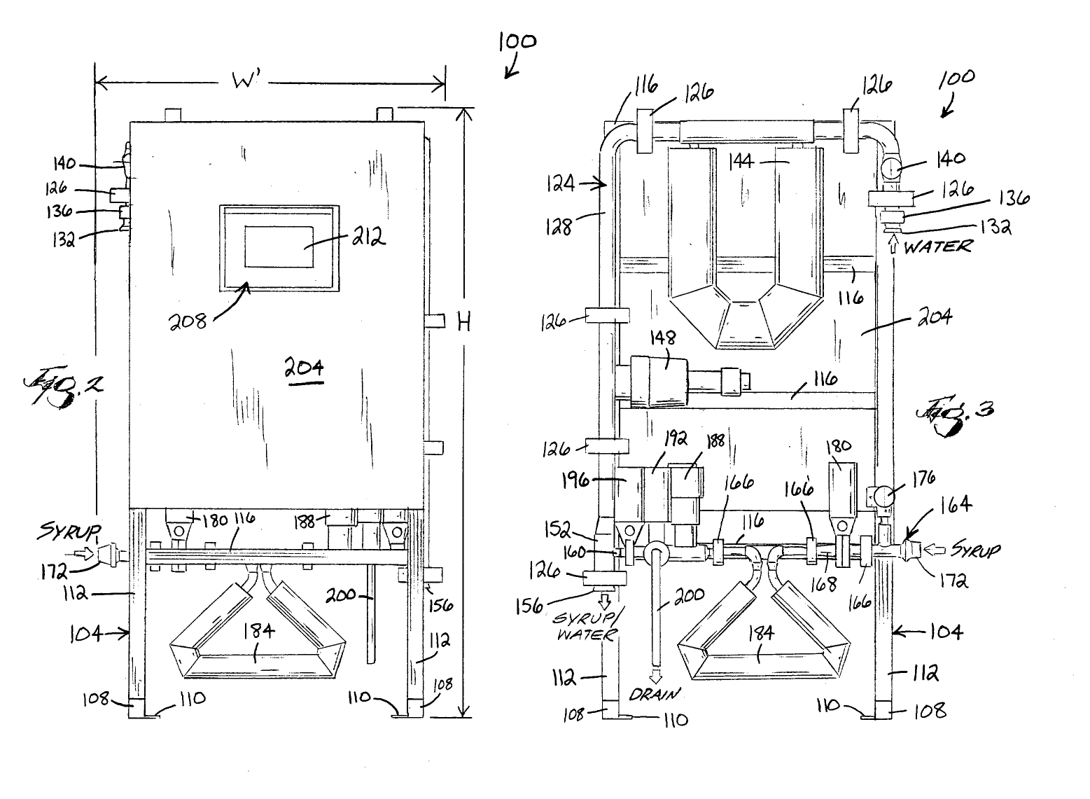

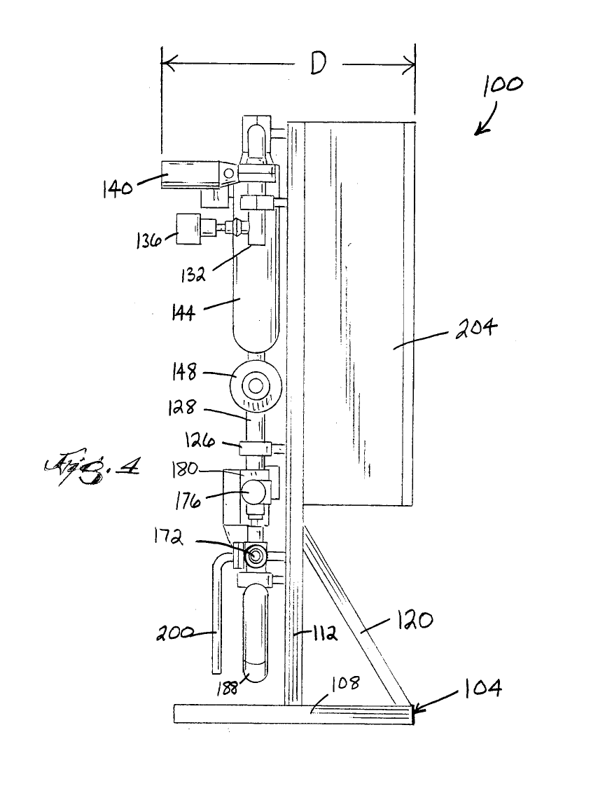

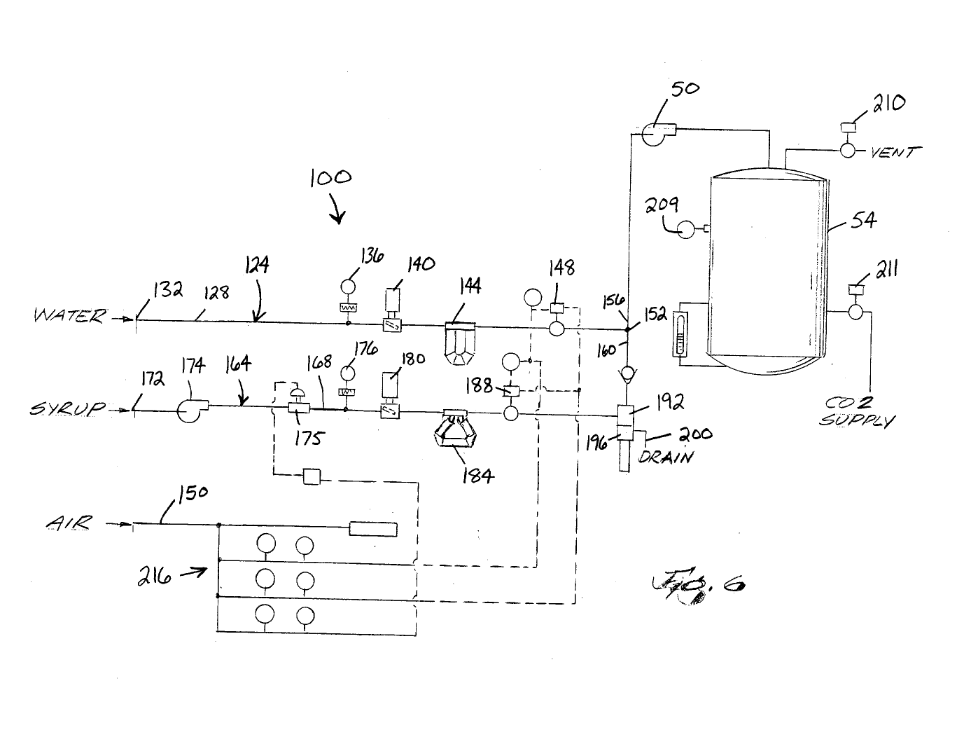

FIGS. 2-5 illustrate a proportioner unit 100 embodying the present invention. As will be described in greater detail below, the proportioner unit 100 is configured to take the place of the proportioning stage components shown in FIG. 1, including the water reservoirs 30, the syrup reservoirs 34, the mixing chamber 38 and the orifices 42 and 46. Referring again to FIG. 1, the proportioner unit 100 is configured to bypass the existing proportioner at bypass or redirect points W, S, and M. In other words, the proportioner unit 100 is coupled to the existing water supply line at or near the bypass point W, the existing syrup supply line at or near the bypass point S, and the mixed fluid line at or near the redirect point M. Any suitable plumbing configurations can be used to effectuate the bypassing and redirecting of the fluids. The existing integral proportioner of the prior art system 10 can be rendered inoperable and left in place, or alternatively can be removed.

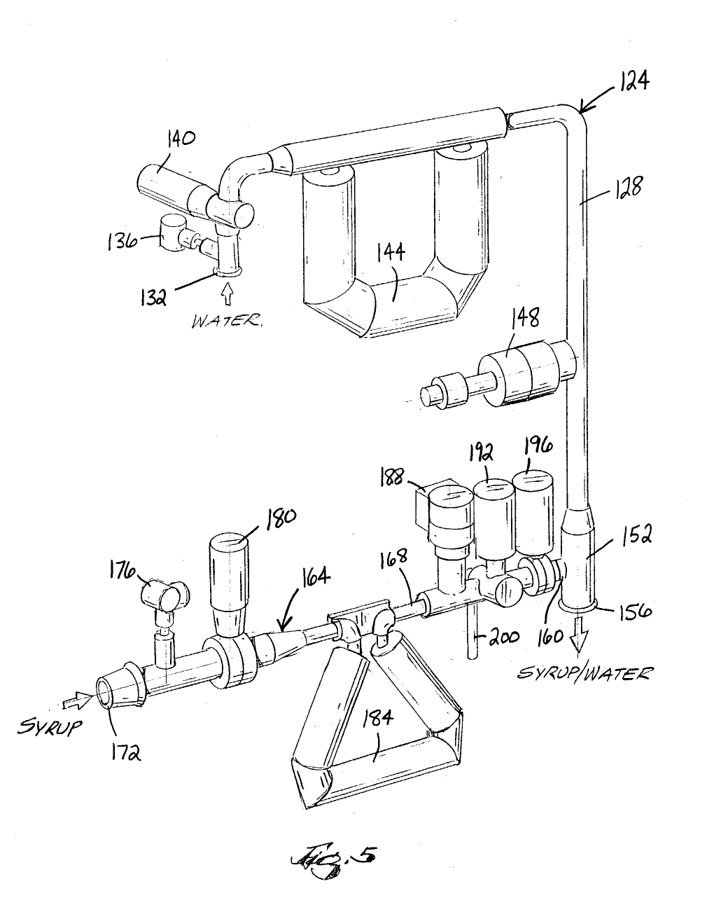

Referring now to FIGS. 2-5, the proportioner unit 100 includes a frame 104 having spaced apart, substantially horizontal base sections 108. Each base section 108 includes one or more mounting feet 110 configured to secure the frame 104 to the underlying surface. A substantially vertical leg section 112 extends from each of the base sections 108. Substantially horizontal cross-members 116 extend between the leg sections 112. Angled brace sections 120 (only one is shown in FIG. 4) extend between each leg section 112 and its corresponding base section 108 for added support. In the illustrated embodiment, the frame 104 is constructed of aluminum, stainless steel, or other metal tubing using conventional welding techniques.

The frame 104 supports a water handling assembly 124. In the illustrated embodiment, the water handling assembly 124 is coupled to the frame 104 with brackets 126 mounted to the leg sections 112 and the upper-most cross-member 116. Of course, the water handling assembly 124 could also be coupled in other ways to other parts of the frame 104.

The water handling assembly 124 includes a main water line 128 having an inlet 132 for connection with the existing water supply system at the bypass point W (see FIG. 1). Downstream of the inlet 132 is a pressure transducer 136 for monitoring the water pressure in the line 128. A butterfly valve 140 is downstream of the transducer 136 and can be adjusted as desired to change the line pressure and flow. Downstream of the butterfly valve 140 is a mass flow meter 144. In the illustrated embodiment, the mass flow meter 144 is a Coriolis type meter, however other types of mass flow meters can also be used. Data outputs from the meter 144 include flow data and temperature data.

Downstream of the meter 144 is a flow control valve 148 that controls the overall flow of water through the line 128. The illustrated flow control valve 148 is an I/P type valve that converts an input current signal (mA) to an output air pressure signal (psi) to open and close the valve as desired. The air supply to the flow control valve 148 comes from an instrument air line 150 (see FIG. 6) in the plant. Of course, other types of non-pneumatic flow control valves, such as electrically or mechanically operated valves can also be used, however the illustrated pneumatic valve is preferred due to the rapid response times achieved.

Downstream of the flow control valve 148 is a tee joint 152 having a syrup/water mixture outlet 156. The outlet 156 is configured for connection with the existing mixed fluid line at the redirect point M (see FIG. 1). The tee joint 152 also includes a syrup inlet 160 for the introduction of syrup into the tee joint 152 for mixing, as will be further described below.

The frame 104 also supports a syrup handling assembly 164. In the illustrated embodiment, the syrup handling assembly 164 is coupled to the frame 104 with brackets 166 mounted to the lower-most cross-member 116. Of course, the syrup handling assembly 164 could also be coupled in other ways to other parts of the frame 104.

The syrup handling assembly 164 includes a main syrup line 168 having an inlet 172 for connection with the existing syrup supply system at the bypass point S (see FIG. 1). If needed, an optional syrup booster pump 174 (see FIG. 6) can be incorporated upstream or downstream of the inlet 172. The booster pump 174 can be connected to the frame 104 or can stand alone separately from the proportioner unit 100. If the booster pump 174 is used, an optional pressure regulator valve 175 (see FIG. 6) can be used to help regulate the line pressure downstream of the booster pump 174. In the illustrated embodiment, the pressure regulator valve 175 is pneumatically operated with air from the air supply line 150.

Downstream of the inlet 172 is a pressure transducer 176 for monitoring the syrup pressure in the line 168. A butterfly valve 180 is downstream of the transducer 176 and can be adjusted as desired to change the line pressure and flow. Downstream of the butterfly valve 180 is a mass flow meter 184. In the illustrated embodiment, the mass flow meter 184 is a Coriolis type meter, however other types of mass flow meters can also be used. The data outputs from the meter 184 include flow data and temperature data, similar to the meter 144 in the water handling assembly 124. In addition, the meter 184 in the syrup handling assembly 164 also provides density data.

Downstream of the meter 184 is a flow control valve 188 that controls the overall flow of syrup through the line 168. The illustrated flow control valve 188 operates in the same manner described above with respect to the flow control valve 148 in the water handling assembly 124.

Downstream of the flow control valve 188 are a pair of valves 192 and 196 that operate to direct the flow through the line 168 in one of two directions. At a first setting, the flow in line 168 is directed out of a drain 200 and is not permitted to enter the tee joint 152 at the syrup inlet 160. At the second setting, the flow in line 168 bypasses the drain 200 and is permitted to enter the tee joint 152 at the syrup inlet 160 for mixing with water in the water line 128. The purpose of these two settings will be described in greater detail below.

The proportioner unit 100 further includes a cabinet 204 mounted on the frame 104. The cabinet 204 houses, among other things, a programmable logic controller (PLC) generally indicated as 208 in FIG. 2. The PLC 208 controls the operation of the proportioner unit 100 and can also be used to control the operation of the existing or newly-added components in the beverage mixing system 10. In this manner, much of the older relay contact technology used in the older existing system 10 can be eliminated.

For example, the PLC 208 can be used to control and regulate the pressure inside the carbonation tank 54. As seen in FIG. 6, a pressure transducer 209, a vent valve 210, and a CO₂ supply valve 211 (see FIG. 6) can be connected to the carbonation tank 54 and electrically connected to the PLC 208 so the PLC 208 can control and regulate the CO₂ pressure in the tank 54 to properly carbonate the product. The PLC 208 can also be used to control the clean-in-place (CIP) routine. Additional analog input signals can also be provided to the PLC 208 for monitoring and controlling other pressures, temperatures, and the like.

In the illustrated embodiment, the PLC 208 is an Allen-Bradley 5000 series controller that is PC based and that includes a color touch screen interface 212 for easy and intuitive operator control. The PLC 208 can store a large number of product recipes, including settings for carbonation pressure and beverage brix targets. The PLC 208 and/or the PC is equipped with a modem (not shown) to provide remote access for technicians.

In addition to housing the PLC 208 and the PC, the cabinet 204 can house some or all of the pneumatic system 216 (see FIG. 6) used to control the optional pressure regulator 175 and the flow control valves 148 and 188 in a conventional manner.

The proportioner unit 100 has a relatively small footprint, making the unit 100 well suited for use as a modular, compact upgrade kit to existing prior art blending systems 10 having integral volumetric proportioners. In the illustrated embodiment, the unit 100 has an overall width W′ (see FIG. 2) of approximately forty to forty-five inches, and more preferably about forty-two inches. The unit 100 has an overall height H of approximately seventy-four to seventy-eight inches, and more preferably about seventy-six inches. The unit 100 has an overall depth D (see FIG. 4) of approximately twenty-eight to thirty-two inches, and more preferably about thirty inches.

With reference to FIG. 6, the operation of the proportioner unit 100 will now be described. The operation is automatically controlled by the software loaded onto the PLC 208. At system startup, the syrup line 168 is filled with deaerated water that was previously used to flush the line 168 between a product changeover or to flush the line 168 after a clean-in-place (CIP) routine.

Once the operator has selected a product recipe, syrup is sent from a syrup supply and enters the syrup inlet 172. The optional booster pump 174 and pressure regulator 175 can be employed to achieve the desired syrup pressure and flow. This beginning stage is known as the “syrup push,” where the syrup is used to push or purge the water from the line 168 and out of the drain 200. During the syrup push, the meter 184 is monitoring the density of the water/syrup mixture. When the water/syrup mixture reaches a predetermined density, which the PLC 208 converts to a percent solid value (approximately thirty-five percent solid in the illustrated embodiment), the PLC 208 determines that the water/syrup mixture has a sufficient amount of syrup to begin blending and making product. With this method, the proportioner unit 100 provides for a no-dump startup. In other words, no blended product is wasted during the time when the system is approaching steady-state operation, and the proportioner unit 100 maximizes the amount of product that can be blended at startup.

When the syrup content is sufficient to begin blending, the valves 192 and 196 are switched to the second setting, where the drain 200 is closed and the water/syrup mixture enters the tee joint 152 at the syrup inlet 160. The operator then starts the blending process so that water from the water handling assembly 124 and syrup from the syrup handling assembly 164 are blended in the tee joint 152 and continue mixing on the way to the carbonation tank 54.

The PLC continuously monitors the density of the water/syrup mixture passing through the flow meter 184 and adjusts the flow of syrup through the line 168 using the flow control valve 188. This continual adjustment provides accurate brix blending as the water/syrup mixture in the syrup line 168 approaches one hundred percent syrup (i.e., the water present in the line 168 at startup is substantially purged). In the illustrated embodiment, the flow of water through the main water line 128 remains constant after the proper setting is achieved with the flow control valve 148, and only the flow in the syrup line 168 is varied.

In addition to compensating for the proportionally changing water/syrup mixture in the syrup line 168 at startup, the PLC 208 also takes into account the fact that some residual water will remain in the carbonation tank 54 and in the filler bowl (not shown) after a changeover. Therefore, the PLC 208 artificially elevates the target product brix value for a predetermined amount of blended product. This means that the blended mixture exiting at the mixture outlet 156 will have a slightly higher syrup content to accommodate the expected dilution caused by the residual water in the carbonation tank 54 and the filler bowl. This operation also helps to achieve the no-dump startup.

The proportioner unit 100 operates in a similar manner at syrup run-out. When the syrup supply tank is empty, the operator initiates the end-of-run cycle, wherein the remaining syrup in the syrup line 168 is pushed through by water introduced into the line 168. The meter 184 continuously monitors the density of the syrup/water mixture in the syrup line 168. When the syrup/water mixture reaches a predetermined density, which the PLC 208 converts to a percent solid value (again, approximately thirty-five percent solid in the illustrated embodiment), the PLC 208 determines that the syrup/water mixture no longer has a sufficient amount of syrup to continue blending and making product. At this point, blending is stopped and the valves 192 and 196 are set to the first position so that the remaining syrup/water mixture in the line 168 can be purged via the drain 200. With this technique, the proportioner unit 100 maximizes the amount of product that can be blended at syrup run-out.

The PLC 208 controls brix blending based on mass metering as opposed to volumetric metering used in many prior art proportioners. Because mass metering is unaffected by temperature, pressure, and viscosity variations, the proportioner unit 100 achieves a blending accuracy of approximately ±0.03° brix over the entire blending cycle, whereas the prior art volumetric metering proportioners typically achieve only ±0.10° brix to ±0.05° brix, and only during steady-state operation. Mass metering also permits the proportioner unit 100 to perform automatic flavor cuts and changeovers.

The software in the PLC 208 operates to achieve brix blending in the following manner. First, the final product brix value stored in the PLC 208 with the product recipe is converted to a final product solid fraction value. Of course, it is recognized that fractional values can be readily converted to percentage values (multiplying by 100%) so that solid fraction values and percent solid values can be used interchangeably. The algorithm for the conversion between the final product brix and the final product solid fraction is stored in the PLC 208 and is well known to those skilled in the art of brix blending. By converting from the final product brix value to the final product solid fraction value, and by using the solid fraction values throughout, the algorithm eliminates the use of brix-to-solid offsets or multipliers that can lead to less accurate blending.

The final product solid fraction value can be represented by the following equation:

Solid Fraction(Final Product)=[Wt Solid(Final Product)]/[Total Wt(Final Product)]

As the syrup/water mixture or the syrup alone flows through the meter 184, the density value is converted by the PLC 208 into a syrup solid fraction value. The syrup solid fraction value can be represented by the following equation:

Solid Fraction (Syrup)=[Wt Solid(Syrup)]/[Total Wt(Syrup)]

Next the PLC 208 calculates a syrup recipe fraction according to the following equation:

Syrup Recipe Fraction=Solid Fraction(Final Product)]/Solid Fraction (Syrup)]

With the syrup recipe fraction determined, the PLC 208 can determine the desired water recipe fraction using the equation:

Water Recipe Fraction=1−Syrup Recipe Fraction

Next, the total system flow is determined based on a preset water flow rate through the water line 128:

Total System Flow=[Preset water flow rate(lb/hr)]/[Water Recipe Fraction]

Once the total system flow is known, the desired syrup flow rate can be determined:

Syrup Flow Rate=Total System Flow*Syrup Recipe Fraction

This sequence of calculations is continuously performed by the PLC 208 to set and vary the metering position of the flow control valve 188 in the syrup handling assembly 164. Because the density of the syrup is continuously monitored by the flow meter 184, the actual Solid Fraction (Syrup) value is always known and is used to continuously repeat the above-described algorithm and determine the instantaneous syrup flow rate necessary to blend to brix.

It is this continuous calculation and the corresponding actuation of the flow control valve 188 that automatically and instantaneously compensates for the varying proportions of syrup and water in the syrup line 168 at both startup and run-out. Additionally, the algorithm and corresponding flow control valve actuation accommodates for variations and deviations from the manufacturer's stated syrup brix value/solid fraction value during steady-state operation. This algorithm also permits the temporary, artificial elevation of the final product brix value necessary to account for the residual water in the carbonation tank 54 and the filler bowl at startup.

All of the features and techniques described above make the self-contained proportioner unit 100 a viable and economically-justifiable upgrade or retrofit to pre-existing beverage blending systems incorporating less accurate proportioners.

Additional features of the invention are set forth in the following claims.

1. A self-contained proportioner unit for use in a beverage blending system including a water source and a syrup source, the self-contained proportioner unit comprising:
a frame configured to be distinct and separate from the beverage blending system, such that the self-contained proportioner unit can be moved independently of the beverage blending system;
a water handling assembly supported by the frame and configured to be coupled to the water source;
a syrup handling assembly supported by the frame and configured to be coupled to the syrup source;
a controller supported by the frame and operable to control a flow of water through the water handling assembly and a flow of syrup through the syrup handling assembly; and
an outlet fluidly connected to the water handling assembly and the syrup handling assembly and configured to be coupled with the beverage blending system to discharge blended beverage;
wherein the self-contained proportioner unit blends syrup and water using mass flow metering technology.

2. The self-contained proportioner unit of claim 1, further comprising a drain supported by the frame and communicating with the syrup handling assembly.

3. The self-contained proportioner unit of claim 1, wherein the water handling assembly includes a mass flow meter.

4. The self-contained proportioner unit of claim 3, wherein the mass flow meter is a Coriolis type mass flow meter.

5. The self-contained proportioner unit of claim 1, wherein the syrup handling assembly includes a mass flow meter.

6. The self-contained proportioner unit of claim 5, wherein the mass flow meter is a Coriolis type mass flow meter.

7. The self-contained proportioner unit of claim 5, wherein the mass flow meter is configured to provide density data from the syrup handling assembly to the controller.

8. The self-contained proportioner unit of claim 1, wherein the unit has an overall width W′ of about forty to forty-five inches, an overall height H of about seventy-four to seventy-eight inches, and an overall depth D of about twenty-eight to thirty-two inches.

9. The self-contained proportioner unit of claim 8, wherein the unit has an overall width W′ of about forty-two inches, an overall height H of about seventy-six inches, and an overall depth D of about thirty inches.

10. The self-contained proportioner unit of claim 1, wherein the controller is a programmable logic controller.

11. The self-contained proportioner unit of claim 1, further comprising a cabinet supported by the frame for housing the controller.

12. The self-contained proportioner unit of claim 11, wherein the cabinet is sized to further house a pneumatic system that controls at least one component of the self-contained proportioner unit.

13. A method of bypassing an integral proportioner of a beverage blending system, the integral proportioner communicating at an inlet end with a water supply of the beverage blending system and a syrup supply of the beverage blending system, and the integral proportioner communicating at an outlet end with a product tank of the beverage blending system, the method comprising:
breaking communication between the integral proportioner and the water supply;
breaking communication between the integral proportioner and the syrup supply;
breaking communication between the integral proportioner and the product tank;
providing a self-contained proportioner unit having a frame configured to remain distinct and separate from the beverage blending system, such that the integral proportioner need not be removed from the beverage blending system;
providing communication between the self-contained proportioner unit and the water supply, such that water from the water supply bypasses the integral proportioner;
providing communication between the self-contained proportioner unit and the syrup supply, such that syrup from the syrup supply bypasses the integral proportioner; and
providing communication between the self-contained proportioner unit and the product tank, such that syrup and water blended by the self-contained proportioner unit are directed into the product tank.

14. The method of claim 13, wherein the self-contained proportioner unit includes a water handling assembly and a syrup handling assembly, and wherein the method further includes controlling a flow of water through the water handling assembly and a flow of syrup through the syrup handling assembly.

15. The method of claim 13, further comprising:
blending syrup and water in the self-contained proportioner unit using a mass flow meter.

16. The method of claim 15, wherein the self-contained proportioner unit includes a controller, and wherein the controller controls blending of the syrup and water by converting a stored final product brix value to a final product solid fraction value.

17. The method of claim 16, wherein the controller controls a flow of syrup in the self-contained proportioner unit by
a) calculating a solid fraction value of the syrup according to the equation
Solid Fraction(Syrup)=[Wt Solid(Syrup)]/[Total Wt(Syrup)];
b) calculating a syrup recipe fraction value according to the equation
Syrup Recipe Fraction=Solid Fraction(Final Product)]/Solid Fraction(Syrup)]
wherein the solid fraction of the final product is determined based on the stored final product brix value;
c) calculating a desired water recipe fraction value according to the equation
Water Recipe Fraction=1−Syrup Recipe Fraction;
d) calculating a total system flow value according to the equation
Total System Flow=[Preset waterflow rate(lb/hr)]/[Water Recipe Fraction];
and
e) calculating a desired syrup flow rate value according to the equation
Syrup Flow Rate=Total System Flow*Syrup Recipe Fraction.

18. The method of claim 13, wherein prior to being bypassed, the integral proportioner of the beverage blending system blended beverage using volumetric metering technology.

19. The method of claim 13, wherein providing the self-contained proportioner unit further includes
positioning the frame adjacent the beverage blending system; and
securing the frame to an underlying surface.

20. The method of claim 13, wherein the self-contained proportioner unit includes a controller, and wherein the method further comprises:
using the controller to control at least one component of the beverage blending system.
